(19) United States
(12) Patent Application Publication
(10) Pub. No.: US 2020/0174387 A1
(43) Pub. Date: Jun. 4, 2020

(54) IMAGE FORMING METHOD

(71) Applicant: Konica Minolta, Inc., Tokyo (JP)

(72) Inventors: Ryuichi Hiramoto, Kobe-shi (JP); Michiyo Fujita, Tokyo (JP); Tomoko Mine, Tokyo (JP); Kaori Matsushima, Tokyo (JP)

(21) Appl. No.: 16/599,737

(22) Filed: Oct. 11, 2019

(30) Foreign Application Priority Data
Nov. 29, 2018 (JP) 2018-223063

(51) Int. Cl. G03G 9/08; G03G 15/08; G03G 15/04

(52) U.S. Cl. CPC G03G 9/0821; G03G 15/04; G03G 15/08

(57) ABSTRACT

Provided is an image forming method including the step of: supplying powder particles to a resin image layer formed on a recording medium to adhere the powder particles to the resin image layer, wherein 80% or more of the powder particles out of the total number of the powder particles adhered to a surface and an inside of the resin image layer are adhered so that at least a part of each powder particle is exposed from the resin image layer.

### CROSS-REFERENCE TO RELATED APPLICATION

The entire disclosure of Japanese Patent Application No. 2018-223063 filed on Nov. 29, 2018 with Japan Patent Office is incorporated herein by reference in its entirety.

### BACKGROUND

### 1. Technological Field

The present invention relates to an image forming method for fixing powder particles to a resin image layer. More specifically, the present invention relates to an image forming method which enables to express a higher metallic luster feeling (specifically, metallic mirror feeling) in the case of powder particles having a metallic luster feeling, and an image forming method in which powder particles are hardly detached.

### 2. Description of the Related Art

In recent years, in the on-demand printing market, the demand for feature printing and high value-added printing is increasing. Above all, requests for metallic printing are particularly large, and various studies have been conducted. Here, metallic printing refers to printing of an image having metallic gloss. As one of the methods, a method of transferring a metal foil or a resin foil using a toner as an adhesive layer has been considered. For example, Patent Document 1 (JP-A 01-200985) proposes a method of forming a toner image and adhering a transfer foil only to the toner portion. In this method, when the foil is transferred to only a part of the image, there is a problem that all the remaining foil is wasted.

On the other hand, studies have also been made to add a bright pigment to a toner. For example, in Patent Document 2 (JP-A 2014-157249), there is proposed a method of forming a metallic image only on a necessary portion by containing a bright pigment in a toner. However, this method has not reached the required metallic feeling.

In view of this, a technique has been proposed in which powder particles are adhered to the image surface to give a metallic feeling in order to form an image with a high metallic feeling in a necessary portion without waste. For example, in Patent Document 3 (JP-A 2013-178452), it is proposed a method in which a toner image is softened by heating a toner image to generate an adhesive force (sticking force), and the adhesive force is used to adhere and fix powder particles to express a metallic feeling.

However, this method has a problem in the adhesive force of the powder particles, and the powder particles are likely to be detached due to rubbing, resulting in a decrease in metallic feeling.

### SUMMARY

The present invention has been made in view of the above problems and circumstances. An object of the present invention is to provide an image forming method which enables to express a higher metallic luster feeling (specifically, metallic mirror feeling) in the case of powder particles having a metallic luster feeling, and an image forming method in which powder particles are adhered to a resin image layer and hardly detached. In order to solve the above problems, the present inventors investigated the cause of the above problems, and found the following image forming method. In this image forming method, by setting the exposure ratio of the total number of powder particles adhered to the surface and the inside of the resin image layer to be a specific value or more, and by adhering a part of each powder particle so as to be exposed from the resin image layer, in the case of powder particles with a metallic luster, a higher metallic luster (specifically, metallic mirror feeling) can be expressed, and the powder particles are hardly detached. That is, the above-mentioned problem according to the present invention is solved by the following means.

To achieve at least one of the abovementioned objects, according to an aspect of the present invention, an image forming method that reflects an aspect of the present invention is an image forming method comprising the step of: supplying powder particles to a resin image layer formed on a recording medium to adhere the powder particles to the resin image layer, wherein 80% or more of the powder particles out of the total number of the powder particles adhered to a surface and an inside of the resin image layer are adhered so that at least a part of each powder particle is exposed from the resin image layer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1A is a schematic diagram for explaining the image forming method of the present invention.

FIG. 1B is a schematic diagram for explaining the image forming method of the present invention.

FIG. 1C is a schematic diagram for explaining the image forming method of the present invention.

FIG. 2 is a photograph taken with a scanning electron microscope for explaining the image forming method of the present invention.

FIG. 3 is a schematic diagram for explaining the calculation method of the exposure amount of the powder particle according to the present invention.

FIG. 4 is a schematic diagram for explaining the exposure of powder particles according to the present invention.

FIG. 5 is a schematic diagram for explaining the exposure of powder particles according to the present invention.

FIG. 6A is a schematic diagram for explaining the image forming method of the present invention.

FIG. 6B is a schematic diagram for explaining the image forming method of the present invention.

FIG. 7 is a schematic diagram for explaining the major axis, the minor axis and the thickness of the powder particles according to the present invention.

FIG. 8A is a schematic diagram for explaining the adhered state of conventional powder particles.

FIG. 8B is a schematic diagram for explaining the adhered state of conventional powder particles.

### DETAILED DESCRIPTION OF THE EMBODIMENTS

Hereinafter, one or more embodiments of the present invention will be described with reference to the drawings. However, the scope of the invention is not limited to the disclosed embodiments.

By the above means of the present invention, in the case of powder particles having a metallic luster feeling, it is possible to provide an image forming method which is capable of expressing a higher metallic luster feeling (specifically, metallic mirror feeling (a metallic luster feeling with less irregular reflection)). In this image forming method, powder particles adhere to the resin image layer with sufficient adhesion and are hardly detached. According to the means of the present invention, since the powder particles are exposed, the color of the powder particles is not impaired when the powder particles not having metallic luster are used. In addition, even in the case of powder particles obtained by processing the surface shape of the powder particles to give an interference color, an effect that does not impair the decorating property can be obtained. The expression mechanism or action mechanism of the effect of the present invention is not clear, but it is presumed as follows. In general, the larger the particle size of the powder particles, the larger the area that reflects light, and a high metallic mirror feeling can be obtained. As a result, by exposing a part of the resin image layer without completely covering the powder particle with the resin image layer, it is possible to maintain the metallic mirror feeling without reducing the amount of light reflection on the powder particle. Further, by increasing the contact area amount (embedding amount) between the powder particles and the resin image layer, the detachment of the powder particles from the resin image layer can be prevented. That is, for example, as illustrated in FIG. 8A, when the embedding amount of the powder particles 101 into the resin image layer 102 is small, the powder particles 101 are easily detached, and as illustrated in FIG. 8B, when the powder particles 101 are completely covered with the resin image layer 102 and the amount of burying is large, the metallic mirror feeling is lowered. Therefore, in the present invention, each of 80% or more of the powder particles out of the total number of the powder particles adhered to a surface and an inside of the resin image layer are adhered in such a manner that at least a part of each powder particle is exposed from the resin image layer. Thereby, in the case of powder particles with a metallic luster feeling, the powder particles exposed from the resin image layer can express a high metallic luster feeling (specifically, a metallic mirror feeling (a metallic luster feeling with less irregular reflection)). In addition, detachment from the resin image layer can be prevented by burying a part of each powder particle in the resin image layer.

The image forming method of the present invention is an image forming method in which powder particles are supplied and adhered to a resin image layer formed on a recording medium. In this method, 80% or more of the powder particles out of the total number of the powder particles adhered to a surface and an inside of the resin image layer are adhered so that at least a part of each powder particle is exposed from the resin image layer. This feature is a technical feature common to or corresponding to each of the following embodiments.

As an embodiment of the present invention, it is preferable that the resin image layer is a toner image layer formed by using an electrostatic charge image developing toner because the effects of the present invention may be remarkably exhibited.

When the average exposure amount of each powder particle from the resin image layer is in the range of 10 to 50%, it is possible to prevent the powder particles from detaching from the resin image layer while maintaining a high metallic mirror feeling. This is preferable.

The powder particles are preferably flat from the viewpoint that a desired decorative image may be obtained by controlling the orientation of the powder particles.

The average major axis of the powder particles is preferably in the range of 5 to 500 μm, and the average thickness is preferably in the range of 0.2 to 5 μm. By setting the average major axis within the above range, a high metallic mirror feeling may be exhibited, and the powder particles are not detached when the image is rubbed. In addition, by making the average thickness within the above range, the planar direction of the powder particles including the major axis and minor axis directions of the powder particles adhered to the surface of the resin image layer is sufficiently aligned with the powder particles substantially along the surface direction of the resin image layer. Further, by making the average thickness within the above range, the powder particles are not detached when the image is rubbed.

It is preferable that the powder particles contain at least a metal or a metal oxide because a high metallic mirror feeling may be expressed.

The present invention and the constitution elements thereof, as well as configurations and embodiments, will be detailed in the following. In the present description, when two figures are used to indicate a range of value before and after “to”, these figures are included in the range as a lowest limit value and an upper limit value.

### [Outline of the Image Forming Method of the Present Invention]

The image forming method of the present invention is an image forming method in which powder particles are supplied and adhered to a resin image layer formed on a recording medium. In this method, 80% or more of the powder particles out of the total number of the powder particles adhered to a surface and an inside of the resin image layer are adhered so that at least a part of each powder particle is exposed from the resin image layer.

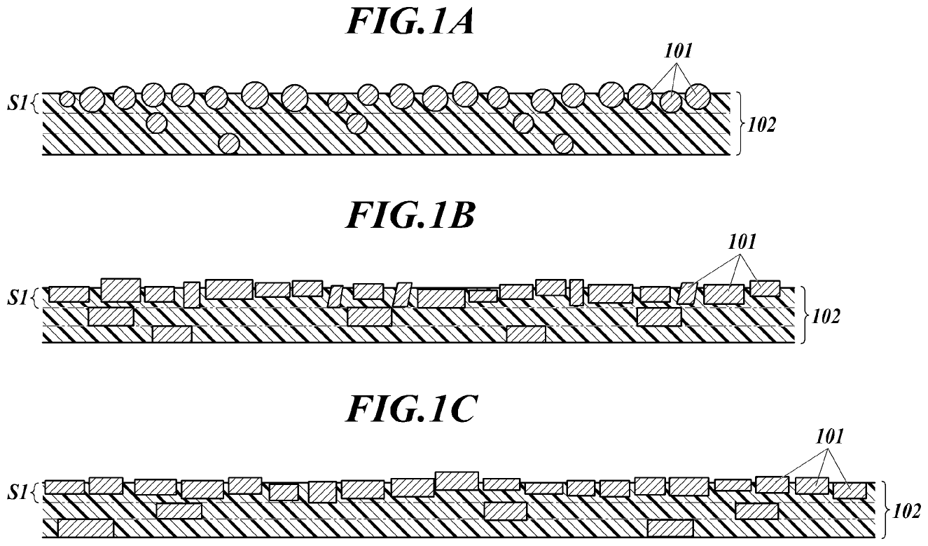

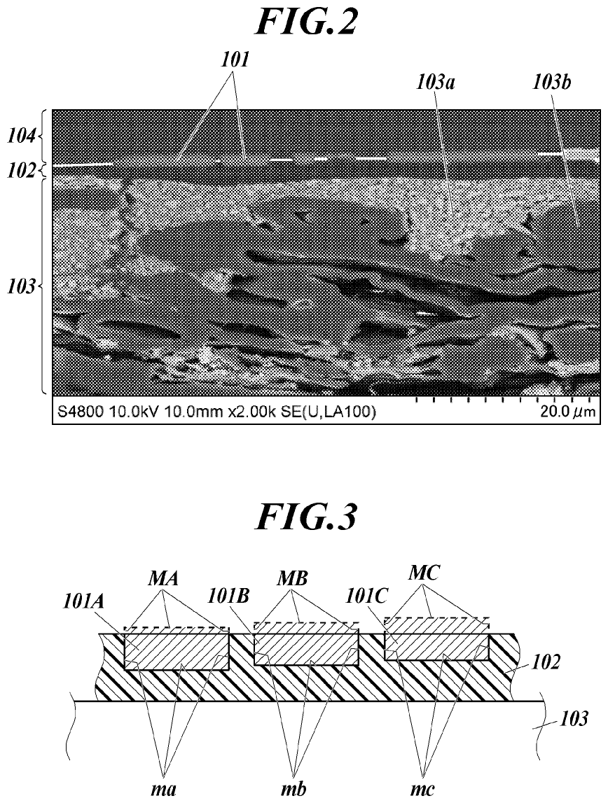

In particular, in a photograph in which a cross section of the resin image layer according to the present invention is observed and photographed with a scanning electron microscope, it is preferable that the region formed by collecting the powder particles of 80% or more is adhered so as to form a single layer. That is, as illustrated in FIG. 1A to FIG. 1C, it is preferable that 80% or more of the powder particles 101 are adhered to the first layer S1 including the surface of the resin image layer 102, and that the first layer S1 is substantially parallel to the surface of the resin image layer 102 and has a single layer structure. Further, it is preferable that less than 20% of the powder particles 101 are adhered to the inside of the resin image layer 102. In the interior of the first layer S1 and the interior of the resin image layer 102, it is preferable to be in a fixed state where the distance between particles is observed in a substantially uniformly dispersed state. Such a fixed state is preferable in that a higher metallic mirror feeling may be obtained. In addition, the surface disturbance of the resin image layer may be prevented, and the image quality may be improved. FIG. 2 is a photograph of a cross section of the resin image layer according to the present invention observed and photographed with a scanning electron microscope at a magnification of 2000 times. In FIG. 2, reference numeral 103 represents paper as a recording medium, reference numeral 103a represents a paper coating layer, reference numeral 103b represents a paper fiber layer, and reference numeral 104 represents an embedded resin layer. In addition, with respect to the part where two powder particles appear to overlap, it is considered to be one layer, when the gap between powder particles is less than the thickness of the powder particles. However, when it is three or more layers, it is not considered to be one layer.

Further, in the present invention, “exposed from the resin image layer” means two cases. In one case, only the surface of the powder particle is exposed in the image (two-dimensional image) observed with a scanning electron microscope, and in other case, the surface and side surface of the powder particle are exposed. In these cases, the exposure amount is calculated by the method described below. When the calculated exposure amount is larger than 0%, it is assumed that the particle is “exposed from the resin image layer”. Further, when the exposure amount is 0%, the particle is “not exposed from the resin image layer”.

### <Calculation of Exposure Amount of Powder Particles>

### (Cross-Sectional Observation Method)

A powder decoration image with powder particles adhered to the surface of the resin image layer is cut out and is solidified with an embedding resin. Then, a cutting sample is prepared. The cutting surface is ion milled with an ion milling device to produce a sample for cross-sectional observation. The observation sample is observed, for example, with an ultra-high resolution field emission scanning electron microscope (S-4800, manufactured by Hitachi High-Technologies Corporation) at a magnification at which ten powder particles adhered to the resin image layer can be seen in one field of view. The observed image is binarized by LUSEX™-AP manufactured by Nireco Corporation, and the exposure amount of each powder particle is calculated by the following method.

### (Exposure Amount)

Exposure amount=(Perimeter of powder particles exposed from resin image layer in cross-sectional image)/(Total perimeter of powder particles in cross-sectional image)×100

Perimeter of exposed powder particles (exposed perimeter): Perimeter of the part exposed from the resin image layer

Total perimeter of powder particles: Length actually measured around the whole circumference of powder particles

The “exposed perimeter” is the length of the broken line portion (exposed upper surface+side surface length MA) in the case of the powder particle 101A in FIG. 3, for example. In the case of powder particle 101B, it is the length of the broken line portion (exposed upper surface+side surface length MB), and in the case of powder particle 101C, it is the length of the broken line portion (exposed upper surface+side surface length MC). The “total perimeter” is the sum (MA+ma) of the length of the broken line portion (MA) and the length of the solid line portion (ma) in the case of the powder particle 101A in FIG. 3, for example. Further, in the case of powder particle 101B, it is the sum (MB+mb) of the length of the broken line portion (MB) and the length of the solid line portion (mb). In the case of powder particle 101C, it is the sum (MC+mc) of the length of the broken line portion (MC) and the length of the solid line portion (mc).

### <Calculation of Exposure Ratio in Total Number of Powder Particles>

In the cross-sectional observation method, the total number of powder particles in one field of view and the number of powder particles having an exposure amount greater than 0% are counted, and the exposure ratio of the total number of powder particles is calculated. This is calculated in 10 arbitral fields of view, and the average value is adopted. Note that powder particles having a diameter of 3 μm or more are counted.

Exposure ratio=(Number of powder particles exposed from resin image layer)/(Total number of powder particles in cross-sectional image)×100

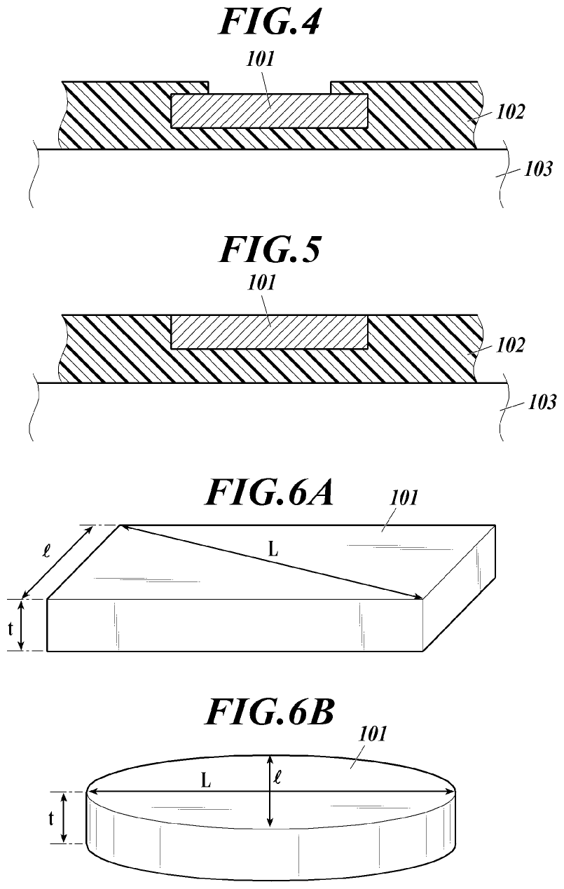

In the present invention, when the exposure amount calculated by the above method is larger than 0%, it is considered to be exposed. For example, as illustrated in FIG. 4, a part of the powder particle 101 is covered with a resin image layer 102. This case is considered as an exposed particle. In particular, as illustrated in FIG. 5, it is preferable that only one surface of the upper surface of the powder particle 101 is completely exposed, and the opposite surface (lower surface) and the surface in the thickness direction are completely buried in the resin image layer 102.

The average exposure amount of each powder particle adhered to the surface of the resin image layer from the resin image layer (average value of the exposure amount of each powder particle of 3 μm or more) is preferably in the range of 10 to 50%. This is preferable in that the powder particles are prevented from being detached from the resin image layer while maintaining a high metallic mirror feeling.

In order to achieved that 80% or more of the powder particles out of the total number of powder particles adhered to the resin image layer are adhered so that at least a part of each powder particle is exposed from the resin image layer, a preferable embodiment is as follows. As will be described later, it is preferable to include a heating means for heating the resin image layer, a powder supply means for supplying powder particles onto the resin image layer that is melted or softened by heating, and a rubbing-adhering means for rubbing and adhering the resin image layer supplied with the powder particles, and to control conditions such as heating temperature, powder particle supply rate, rubbing speed and rubbing time for the resin image layer.

### <Coverage>

The coverage of the resin image layer with the powder particles is preferably in the range of 30 to 80%. Within this range, the metallic feeling is not a uniform specular gloss, but can have a brilliant glitter. The above-mentioned coverage means a coverage with the powder particles to a decoration area (area where powder particles are to be adhered). Specifically, the coverage is measured using a Keyence digital microscope VHX-6000 at a magnification of 100, and photographs are taken for 10 arbitral fields of view, and binarization processing is performed with LUSEX™-AP by Nireco Corporation. Each coverage is obtained for 10 fields of view by the following formula, and an average of these values is adopted.

Coverage=(Area exposed from the surface of the resin image layer when viewed from above the powder particles)/(Area of the surface of the resin image layer)×100

In addition, it is preferable that the part covered with the powder particles and the part not covered are uniformly dispersed.

### [Image Forming Method]

Hereinafter, the configuration of the image forming method of the present invention will be described.

### <Recording Medium>

The recording medium according to the present invention is not particularly limited. Examples thereof include: plain papers from thin paper to thick paper, high quality paper, coated printing paper such as art paper or coated paper, Japanese paper or postcard paper commercially available; resin films such as polypropylene (PP) film, polyethylene terephthalate (PET) film, and triacetyl cellulose (TAC) film; and cloths. The present invention is not limited to them. Further, the color of the recording medium is not particularly limited, and various color recording media may be used.

### <Resin Image Layer>

The resin image layer is not particularly limited as long as the powder particles may be adhered to the surface. For example, the resin image layer preferably contains a resin that is softened or plasticized by heating. In addition, it is preferable that the resin image layer is a toner image layer formed using a toner for developing an electrostatic image, since the effects of the present invention may be remarkably exhibited. Examples of such a resin include a thermoplastic resin and a hot melt resin. In addition to the resin, other components such as a colorant, a dispersant, a surfactant, a plasticizer, a releasing agent, and an antioxidant may be contained in the layer.

The thermoplastic resin may be a known resin having thermoplasticity and is not particularly limited. Further, as the hot melt resin, a known resin having hot melt property may be used, and it is not particularly limited.

Examples of the thermoplastic resin and the hot melt resin include: (meth)acrylic resin, styrene resin, styrene-acrylic resin, olefin resin (including cyclic olefin resin), polyester resin, polycarbonate resin, polyamide resin, polyphenylene ether resin, polyphenylene sulfide resin, halogen-containing resin (polyvinyl chloride, poly vinylidene chloride, and fluorine resin), polysulfone resin (polyether sulfone and polysulfone), cellulose derivative (cellulose ester, cellulose carbamate, and cellulose ether), silicone resin (polydimethylsiloxane and polymethylphenyl siloxane), polyvinyl ester resin (polyvinyl acetate), acrylonitrile-butadiene-styrene copolymer (ABS resin), polyvinyl alcohol resin and derivatives thereof, rubber and elastomer (diene rubber such as polybutadiene and polyisoprene, styrene-butadiene copolymer, acrylonitrile-butadiene copolymer, acrylic rubber, and urethane rubber). The thermoplastic resin and the hot melt resin may be used alone or in combination of two or more. In the present specification, “(meth)acrylic” refers to “acrylic and/or methacrylic”.

The thermoplastic resin and the hot melt resin may be a copolymer. When the thermoplastic resin is a copolymer, the form of the copolymer may be any of a block copolymer, a random copolymer, a graft copolymer, and an alternating copolymer.

Further, as the thermoplastic resin and the hot melt resin, a synthetic product may be used or a commercially available product may be used. The polymerization method for synthesizing these thermoplastic resin and hot melt resin is not particularly limited, and known methods may be used. For example, high pressure radical polymerization method, medium and low pressure polymerization method, solution polymerization method, slurry polymerization method, bulk polymerization method, emulsion polymerization method, and gas phase polymerization method may be mentioned. Also, the radical polymerization initiator and catalyst used during polymerization are not particularly limited. For example, radical polymerization initiators such as azo or diazo polymerization initiators and peroxide polymerization initiators; polymerization catalysts such as peroxide catalysts, Ziegler-Natta catalysts, and metallocene catalysts may be used.

From the viewpoint of easily controlling the surface state of the resin image layer, the thermoplastic resin and the hot melt resin contain, among the above-mentioned resins, at least one selected from the group consisting of (meth) acrylic resin, styrene resin, styrene-acrylic resin, and polyester resin. More preferably, they contains at least one selected from the group consisting of styrene-acrylic resin and polyester resin.

The styrene-acrylic resin, as referred to in the present invention, is formed by polymerization using at least a styrene monomer and a (meth)acrylic acid ester monomer. In this specification, the styrene monomer indicates styrene represented by the formula CH₂═CH—C₆H₅, and also includes monomers having a known side chain or functional group in a styrene structure.

Moreover, a (meth)acrylic acid ester monomer is a monomer having a functional group which has an ester bond in a side chain. Specifically, in addition to an acrylic acid ester monomer represented by CH₂═CHCOOR (R is an alkyl group), a vinyl ester compound such as a methacrylic acid ester monomer represented by CH₂═C(CH₃)COOR (R is an alkyl group) is included.

In the styrene-acrylic resin, besides the copolymer formed only of the above-mentioned styrene monomer and (meth)acrylic acid ester monomer, copolymers formed using further common vinyl monomers (olefins, vinyl esters, vinyl ethers, vinyl ketones, and N-vinyl compounds) are included.

Further, in the styrene-acrylic resin, copolymers formed with a multifunctional vinyl monomer and a vinyl monomer having an ionic dissociative group (a carboxy group, a sulfonic acid group, or a phosphoric acid group) in a side chain in addition to a styrene monomer, a (meth)acrylic acid ester monomer and other common vinyl monomer. Examples of such vinyl monomers include, for example, acrylic acid, methacrylic acid, maleic acid, and itaconic acid.

The polyester resin is a known polyester resin obtained by the polycondensation reaction of a divalent or higher valent carboxylic acid (polyvalent carboxylic acid component) and an alcohol having a divalent or higher valent (polyhydric alcohol component). The polyester resin may be amorphous or crystalline. The number of valences of the polyvalent carboxylic acid component and the polyhydric alcohol component is preferably 2 to 3, and particularly preferably it is respectively 2. Therefore, the case where the valence number is 2 (i.e., the dicarboxylic acid component and the diol component) will be described as a particularly preferred embodiment. Examples of the dicarboxylic acid component include: saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid; unsaturated aliphatic dicarboxylic acids such as methylenesuccinic acid, fumaric acid, maleic acid, 3-hexendiodic acid, 3-octendioic acid, and dodecenyl succinic acid; and unsaturated aromatic dicarboxylic acids such as phthalic acid, terephthalic acid, isophthalic acid, t-butyl isophthalic acid, tetrachlorophthalic acid, chlorophthalic acid, nitrophthalic acid, p-phenylenediacetic acid, 2,6-naphthalenedicarboxylic acid, 4,4′-biphenyldicarboxylic acid, and anthracene dicarboxylic acid. In addition, lower alkyl esters and acid anhydrides of these compounds may also be used. The dicarboxylic acid components may be used alone or in combination of two or more.

In addition, trivalent or higher polyvalent carboxylic acids such as trimellitic acid and pyromellitic acid, anhydrides of the above carboxylic acid compounds, and alkyl esters having 1 to 3 carbon atoms may also be used.

Examples of the diol component include: saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosandiol, and neopentyl glycol; unsaturated aliphatic diols such as 2-butene-1,4-diol, 3-butene-1,4-diol, 2-butyne-1,4-diol, 3-butyne-1,4-diol, and 9-octadecene-7,12-diol; aromatic diols such as bisphenols (bisphenol A and bisphenol F), and alkylene oxide adducts of these compounds (ethylene oxide adduct and propylene oxide adduct), and derivatives thereof. The diol components may be used alone or in combination of two or more. The method for producing the polyester resin is not particularly limited, and examples thereof include a method of polycondensation (esterification) of the polyvalent carboxylic acid component and the polyhydric alcohol component using a known esterification catalyst.

The weight average molecular weight of the resin contained in the resin image layer is not particularly limited, but is preferably in the range of 2,000 to 1,000,000, more preferably in the range of 5,000 to 100,000, and particularly preferably in the range of 10,000 to 50,000.

### (Weight Average Molecular Weight (Mw) and Number Average Molecular Weight (Mn))

The resin to be measured was dissolved in tetrahydrofuran (THF) to a concentration of 1 mg/mL, and then filtered using a membrane filter with a pore size of 0.2 μm, and the resulting solution was used as a sample for GPC measurement. GPC analysis conditions indicated below were adopted for the GPC measurement conditions, and a weight average molecular weight or a number average molecular weight of resin contained in a sample were measured.

### <GPC Measurement Conditions>

As a GPC apparatus, “HLC-8120GPC, SC-8020” (made by Tosoh Corporation) was used. Two pieces of “TSKgel, Super HM-H” (6.0 mmID×15 cm, made by Tosoh Corporation) were used as columns. Tetrahydrofuran (THF) was used as an eluent. The analysis was performed at a flow rate of 0.6 mL/min, a sample injection amount of 10 μL, and a measurement temperature of 40° C. using a RI detector. The calibration curve was obtained by using “Polystyrene standard sample, TSK standard” manufactured by Tosoh Corporation. Ten samples of “A-500”, “F-1”, “F-10”, “F-80”, “F-380”, “A-2500”, “F-4”, “F-40”, “F-128” and “F-700” were use. The data collection interval in sample analysis was 300 ms.

The content of the resin in the resin image layer is not particularly limited. From the viewpoint of softening the surface of the resin image layer to facilitate control of the surface state of the resin image layer, it is preferable that the content of the resin is in the range of 0 to 95 mass % with respect to the total mass of the resin image layer. More preferably, it is in the range of 0 to 50 mass %, still more preferably, it is in the range of 5 to 50 mass %, and most preferably, it is in the range of 10 to 50 mass %.

On the other hand, when the resin image layer contains other components (for example, a colorant and a releasing agent) together with the resin, the content of the other components is not particularly limited. From the viewpoint of melting or softening the surface of the resin image layer to facilitate control of the surface state of the resin image layer, it is preferable that the content of the other components is in the range of 3 to 40 mass % with respect to the total mass of the resin image layer. More preferably, it is in the range of 5 to 20 mass %.

The colorant as the other component is not particularly limited, and known dyes and pigments may be used. Examples of the colorant include: carbon black, magnetic material, and iron-titanium complex oxide black; dyes such as C. I. Solvent Yellow 19 and 44; pigments such as C. I. Pigment Yellow 14 and 17; dyes such as C. I. Solvent Red 1 and 49; pigments such as C. I. Pigment Red 5 and 122; dyes such as C. I. Solvent Blue 25 and 36; and pigments such as C. I. Pigment Blue 1 and 7. The colorants are not limited to them.

The releasing agent as the other component is not particularly limited, and a known releasing agent may be used. Examples of the releasing agent include: polyolefin waxes such as polyethylene wax and polypropylene wax; branched hydrocarbon waxes such as microcrystalline wax; long-chain hydrocarbon waxes such as paraffin wax and SASOL wax; dialkyl ketone waxes such as distearyl ketone; ester waxes such as carnauba wax, montan wax, behenyl behenate, trimethylolpropane tribehenate, pentaerythritol tetrabehenate, pentaerythritol diacetate dibehenate, glycerol tribehenate, 1,18-octadecanediol distearate, tristearyl trimellitate, and distearyl maleate; and amide waxes such as ethylenediaminebehenylamide and trimellitic tristearylamide. The present invention is not limited to them.

The thickness of the resin image layer is not particularly limited, and it is preferably, for example, in the range of 1 to 100 μm, and more preferably in the range of 1 to 50 μm. When the thickness of the resin image layer is in the above range, the orientation of the powder may be more easily controlled, and the texture may be easily controlled.

### <Powder Particles>

In the image forming method of the present invention, the powder particles may be appropriately selected according to the purpose of decoration and the desired texture. Here, a powder refers to an aggregate of powder particles, and also refers to a substance that remains in the form of powder in the final image.

### (Details of Powder Particles)

The shape and size of the powder particles supplied onto the resin image layer are not particularly limited, and it is preferable to select an appropriate shape and size to achieve the desired texture.

Powder particles are roughly classified into spherical (spherical powder particles) and non-spherical (non-spherical powder particles) from the viewpoint of shape. The “spherical powder particles” refer to powder particles having an average circularity of 0.970 or more in its cross-sectional shape or projected shape (upper limit: 1.000). The average degree of circularity may be determined according to the “Wadell's equation”, but it may be a value measured using, for example, the following flow type particle image analyzer “FPIA-3000” (manufactured by Sysmex Corporation). Specifically, a measuring sample powder is wetted in an aqueous surfactant solution, and is ultrasonically dispersed for one minute. After making the dispersion, the average circularity is measured with the analyzer “FPIA-3000” in a high power field (HPF) mode at an appropriate density (the number of particles to be detected at an HPF: 4000 particles). The circularity is calculated from the following expression.

Circularity=(Perimeter of a circle having the same projected area as the particle image)/(Perimeter of the projected image of the particle)

The average circularity indicates an arithmetic average value obtained by dividing the sum of circularities of particles by the number of particles. Therefore, “non-spherical powder particles” refer to powder particles other than spherical powder particles and has an average circularity of less than 0.970 in its cross-sectional shape or projected shape.

Among them, the shape of the powder particles is preferably non-spherical from the viewpoint of achieving the desired texture (in particular, the mirror tone) by controlling the orientation of the powder particles. That is, it is preferable that the powder particles contain non-spherical powder particles. Further, from the same viewpoint, it is more preferable that the non-spherical powder particles include flat powder particles (that is, powder particles having a flat shape). Here, as indicated in FIG. 6A and FIG. 6B, “flat” or “flat shape” refers to a shape having a ratio of (l/t) is 5 or more, provided that the maximum length of the powder particle 101 is a major axis L, the maximum length in the direction orthogonal to the major axis L is a minor axis 1, and the minimum length in the direction orthogonal to the major axis L is a thickness t. The term “flat” or “flat shape” include, for example, shapes called flake, scale, plate, and thin layer.

The non-spherical powder particles preferably have an average major axis L in the range of 3 to 600 μm, more preferably in the range of 5 to 500 μm from the viewpoint of sufficiently exhibiting the appearance effect due to the oriented adhesion of the non-spherical powder particles. By setting the average major axis to 3 μm or more, the reflection area becomes sufficient, and a good high metallic mirror feeling can be exhibited. On the other hand, by setting the average major axis to 600 μm or less, it is possible to prevent the detachment of the powder particles from the resin image layer when the image is rubbed. The non-spherical powder particles preferably have an average thickness tin the range of 0.1 to 10 μm, and more preferably in the range of 0.2 to 5 μm. By setting the average thickness to 0.1 μm or more, the plane direction of the non-spherical powder including the major axis direction and the minor axis direction of the non-spherical powder adhered to the surface of the resin image layer is arranged. Thereby a good orientation state of the non-spherical powder substantially along the surface direction of the resin image layer is sufficiently formed. On the other hand, by setting the average thickness to 10 μm or less, it is possible to prevent detachment of the powder particles from the resin image layer when the image is rubbed.

The average thickness of the powder particles is an average value of a thickness optionally measured for 100 arbitral powder particles. The average major axis of the powder particles is an average value of major axis measured for 100 arbitral powder particles. The thickness and particle size (including the major axis and the minor axis) of each powder particle can be measured as follows. The powder particles are scattered and adhered on the double-sided tape, and the surface is observed with a microscope VHX-6000 at a magnification at which the shape of the powder particles can be confirmed. The observed image is binarized by LUSEX™-AP manufactured by Nireco Corporation, by measuring the major axis L, minor axis 1, and thickness t of 100 arbitral powder particles, and an average value of the values measured by the above method is adopted.

The material of the powder particles is not particularly limited, and for example, various materials such as resin, glass, metal, and metal oxide may be used. Among them, the powder particles preferably contain a metal or a metal oxide. When a metal or metal oxide is contained, a high metallic mirror feeling can be expressed in an image having sufficient gloss.

In addition, the material constituting the powder particles may be one kind alone, or two or more kinds. When the powder particles contains two or more kinds of materials, it may be in the form of being uniformly dispersed, or in the form in which one material is laminated (coated) with another material. As such a form, for example, a form in which a cover film (shell) made of metal and metal oxide is laminated on a base material (core) made of resin, or glass; and a form in which a cover film (shell) made of resin, or glass is laminated on a base material (core) made of metal or metal oxide are cited. However, the form is not limited to them.

The aforesaid powder particles may be a synthetic product or a commercially available product. Examples of the non-spherical powder include: METASHINE (registered trademark) (Nippon Sheet Glass Co., Ltd.), Sunshine baby chrome powder, Aurora powder, and Pearl powder (all three are made by GG Corporation), ICEGEL Mirror Metal Powder (TAT Corporation), PIKA ACE (registered trademark) MC Shine Dust, Effect C (Kurachi Co., Ltd.), PREGEL (registered trademark) Magic Powder, Mirror series (Preanfa Co., Ltd.), Bonnail (registered trademark) Shine Powder (Kay's Planning, Inc.), and LG neo (registered trademark) (Oike & Co., Ltd.). Examples of the spherical powder include high-precision UNIBEADS (registered trademark) (Unitika, Ltd.) and Fine Spheres (registered trademark) (manufactured by Nippon Electric Glass Co., Ltd.).

Note that the powder particles supplied onto the resin image layer may be one kind or a mixture of two or more kinds.

The image forming method of the present invention may contain the steps of: supplying powder particles to a resin image layer formed on a recording medium (powder supply step); and rubbing and adhering the powder particles (rubbing-adhering step).

### (Powder Supply Step)

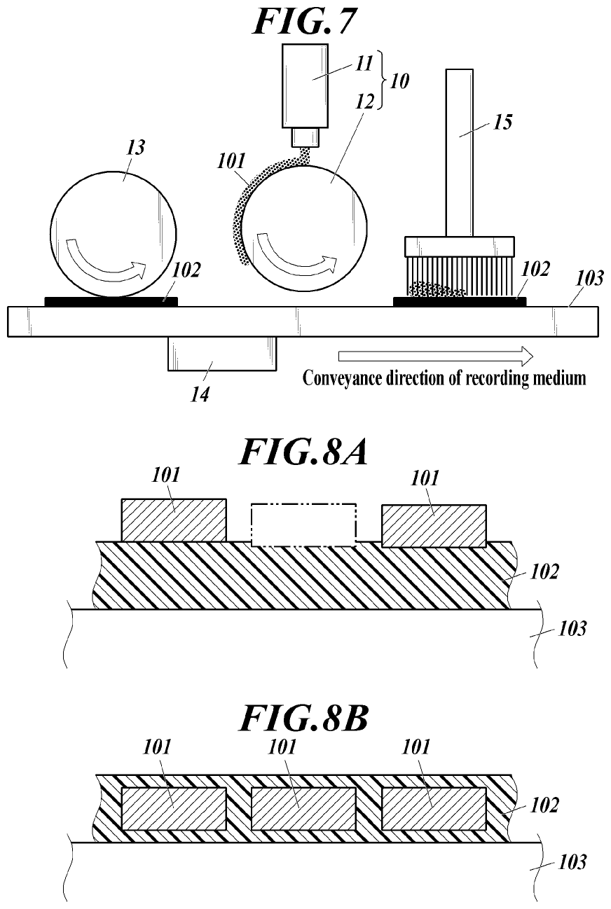

The powder supply step is appropriately selected from either supplying powder particles in advance onto a recording medium, or supplying powder particles onto the aforesaid resin image layer previously formed on the recording medium. The method for supplying the powder particles is not particularly limited, and a known device may be used according to the properties of the powder as the powder supply means in the powder supply step. For example, the powder supply means described in JP-A 2013-178452 (the above-mentioned Patent Document 3) may be used as the powder supply means according to the present invention. In addition, the powder supply means according to an embodiment of the present invention may be a powder supply device 10 including a powder container 11 for storing powder particles 101 and a powder supply roller 12 as indicated in FIG. 7.

A specific example of the powder particles supplying method is as follows. When the powder particles is an insulating powder, the positively or negatively charged insulating powder particles are supplied from the powder container 11 to the conductive powder supply roller (conductive roller) 12, then the above-mentioned insulating powder supported and transported by the conductive roller is supplied onto the resin image layer. That is, when the powder particles are insulating powder particles, it is preferable to use a powder supply device (powder supply means) 10 having a powder container 11 and a conductive powder supply roller (conductive roller) 12.

Another specific example of the powder particles supplying method is as follows. When the powder particles are magnetic powder particles, the magnetic powder particles are supplied from the powder container 11 to the powder supply roller (magnet roller) 12 having magnetism, and the magnetic powder particles are supplied on the resin image conveyed by the magnet roller. That is, when the powder particles are a magnetic powder, it is preferable to use a powder supply device (powder supply means) 10 having a powder container 11 and a powder supply roller (magnet roller) 12 having magnetism.

The amount of the powder particles to be supplied to the resin image layer is not particularly limited, and it is not particularly limited as long as it expresses the desired texture.

The powder particles may be selectively supplied only on the resin image layer, or they may be supplied not only on the resin image layer, but also on the entire surface of the recording medium including the portion where the resin image layer is not formed.

In addition, it is preferable to heat the resin image layer before or after the powder supplying step or at the time of supplying the powder. By heating, the resin image layer is melted or softened, and it is possible that 80% or more of the powder particles out of the total number of powder particles adhered to a surface and an inside of the resin image layer are adhered so that at least a part of each powder particle is exposed from the resin image layer. Specifically, as indicated in FIG. 7, it is preferable to use a heating roller 13, a heater (hot plate) 14, a pressure roller 15 used in a rubbing-adhering step described later. The heating roller heats and melts the resin image layer while conveying the recording medium on which the resin image layer is formed as a means for melting and softening the resin image layer. The heating roller has a rotation axis in a direction perpendicular to the conveyance direction of the recording medium, and sandwiches and conveys the recording medium together with an opposing auxiliary roller (not illustrated). The heating roller has a built-in heater and heats and melts the resin image layer on the recording medium to give the resin image layer adhesiveness. The heating roller is preferably covered with a heat insulating member.

The heater heats the recording medium on which the resin image layer is heated and melted. The heater is provided between the heating roller and the powder supply roller, and heats the back surface of the recording medium. By heating the back surface of the recording medium, a temperature drop of the resin image layer on the recording medium is prevented, and the adhesiveness of the resin image layer is maintained.

It is preferable that the heating temperature of the resin image layer by heating rollers and heater is in the range of 70 to 200° C. from the viewpoint that the powder particles can adhere to the resin image layer with a sufficient adhesive force and can be prevented from being detached while maintaining a high metallic mirror feeling. In addition, although the contact-type heating roller and the heater were mentioned here as a heating means, it is not limited to these. A non-contact-type heating means may be used. Examples of the non-contact heating means include a dryer, an infrared lamp, a visible light lamp, an ultraviolet lamp, and a hot air oven.

### (Rubbing-Adhering Step)

The image forming method of the present invention preferably includes a rubbing-adhering step of rubbing the resin image layer supplied with the powder particles to adhere the powder particles, in addition to the powder supply step. By this, it is possible that 80% or more of the powder particles out of the total number of powder particles adhered to a surface and an inside of the resin image layer are adhered so that a part of the powder is exposed from the resin image layer. The mirror tone texture of the present invention can be exhibited and the detachment of the powder particles can be prevented.

The rubbing-adhering step is a step of adhering the powder particles by rubbing the resin image layer on which the powder particles are adhered from above the powder particles, and is performed after the powder supplying step. “Rubbing” means that the rubbing means (rubbing member) moves relative to the resin image layer along the surface while contacting the surface of the resin image layer on the recording medium. That is, in a state where the resin image layer is pressed, a force is applied in a direction perpendicular to the force simultaneously pressed (a direction parallel to the surface of the resin image layer).

By rubbing the resin image layer in the state in which the powder particles adhere in this manner from above the powder, the powder may be orientated with respect to the surface of the resin image layer. More specifically, by rubbing, the angle of the powder particles with respect to the surface of the resin image layer may be easily aligned, and a mirror tone with less irregular reflection may be easily formed. In particular, when the powder is a flat powder, the flat surface may be oriented along the surface of the resin image layer, so that a mirror tone with less irregular reflection is more effectively formed.

Therefore, the image forming method of the present invention preferably further includes a rubbing-adhering step of rubbing the resin image layer supplied with the powder particles to adhere after the powder supplying step.

Moreover, it is preferable that the said “rubbing” is accompanied by the press of the resin image layer (the resin image to which the powder particles are adhered). That is, in the rubbing-adhering step, it is preferable that the resin image layer supplied with the powder particles is rubbed and pressed. By pressing the resin image layer, a part of the powder is pushed into the inside of the resin image layer, so the adhesion of the powder particles to the resin image layer may be strengthened. Therefore, in addition to the improvement of the strength of the finally formed glossy image, it is possible to make clear the expected appearance such as mirror tone in the formed glossy image. Here, “pressing” refers to pressing the surface of the resin image layer in a direction (e.g., perpendicular direction) intersecting the surface of the resin image layer.

The rubbing-adhering step is performed by rubbing the resin image layer to which the powder particles are adhered, using a rubbing means. Specifically, in the rubbing-adhering step, a rubbing member as a rubbing means is brought into contact with the resin image layer to which the powder is adhered, and rubbing is performed by making the rubbing member to move relative to the resin image layer. At this time, the direction in which the rubbing member is moved is not particularly limited, and may be in only one direction, may be reciprocated, or may be in more directions. However, in order to easily control the orientation of the powder particles and form a texture such as mirror tone with less irregular reflection, it is preferable that the sliding member move in only one direction.

As described above, it is preferable to control the rubbing condition for the purpose of expressing a mirror tone texture. At this time, the rubbing condition includes the rubbing time and the rubbing speed (the relative speed of the rubbing portion of the rubbing member with respect to the surface of the resin image layer), and the pressing force. Further, as described below, when a rotating member is used as the rubbing member, it is preferable to control the rubbing time and the rotation speed as the rubbing conditions.

In the rubbing-adhering process, the rubbing time by the rubbing member is preferably in the range of 2 to 20 seconds from the viewpoint that the powder particles adhere to the resin image layer with sufficient adhesion and the detachment of the powder particles is prevented while maintaining a high metallic mirror feeling. In the rubbing-adhering step, the relative velocity of the rubbing portion of the rubbing member to the surface of the resin image layer is not particularly limited, but is preferably in the range of 5 to 500 mm/sec. When it is 5 mm/sec or more, the orientation of the powder may be sufficiently performed to the surface of the resin image layer. In addition, when it is 500 mm/sec or less, the powder may sufficiently adhere to the resin image layer, and a desired appearance of the mirror tone in the finally formed glossy image may be made clear.

Further, in the rubbing-adhering step, the contact width of the rubbing portion of the rubbing member to the surface of the resin image layer is not particularly limited. From the viewpoint of the desired orientation of the powder adhering to the surface of the resin image layer and the transportability of the recording medium, the thickness is preferably in the range of 1 to 200 mm. When it is 1 mm or more, during the time when the rubbed portion moves along the surface of the resin image layer, variation in the direction of the powder may be suppressed and the orientation of the powder particles adhering to the resin image layer may be sufficiently controlled. When it is 200 mm or less, the recording medium may be transported stably and easily. The “contact width” refers to the length in the moving direction of the rubbing portion of the rubbing member with respect to the resin image layer.

In addition, when pressing is given along with rubbing, the pressing force is not particularly limited. It is preferably in the range of 1 to 30 kPa with respect to the surface of the resin image layer. When it is 1 kPa or more, the adhesion strength of the powder particles to the resin image layer may be sufficiently obtained. When the pressure is 30 kPa or less, the resin image layer formed on the recording medium may be stably held.

The rubbing means used in the rubbing-adhering step is not particularly limited, and a known device may be used. As indicated in FIG. 7, the rubbing member 15 as the rubbing means according to one aspect of the present invention is provided after the powder supply device (powder supply means) 10 with respect to the conveyance direction of the recording medium 103. The arrangement order of these devices is appropriately determined according to the order in which each step is performed.

The rubbing member provided in the rubbing means may be, for example, a rotating member as indicated in FIG. 7. It may be a reciprocating member or a non-rotating member such as a fixed member. More specifically, in order to prevent the powder supplied to the surface of the resin image layer from being completely buried inside the resin image layer, the rubbing member is preferably a member that is capable of rubbing and adhering the powder particles by applying a force from a horizontal direction almost parallel to the surface of the resin image layer. It may be a member that can move relative to the surface in the horizontal direction in contact with the surface of the resin image layer having a horizontal surface. It may be a rotatable roller (rotating roller) that contacts the surface of the resin image layer, a rotating brush (in the form of an electric toothbrush), or a polisher. In addition, in FIG. 7, the rotating brush 15 which is capable of rotating around an axis is illustrated.

When a rotating member (in particular, a rotating brush or a rotating roller) is used as the rubbing member, the rotational speed is not particularly limited.

The rubbing member is preferably a rotating roller, a rotating brush, or a polisher that is configured to be movable relative to the surface of the resin image layer while pressing the resin image layer. When pressing is performed by the rubbing member, for example, the pressing may be performed by pressing the recording medium being transported (the recording medium on which the resin image layer is formed) with the fixed rubbing member. The pressing may be performed by rubbing with a roller that rotates in the same direction as the conveyance direction of the recording medium and rotates at a speed slower than the conveyance speed of the recording medium. It may be performed by rubbing with a roller rotating in a direction opposite to the conveyance direction of the recording medium. Further, pressing may be performed by rubbing with a rotatable roller disposed in a direction in which the rotation axis is oblique to the recording medium conveyance direction. Alternatively, pressing may be performed by rubbing with a member reciprocating on the surface of the resin image layer.

Therefore, it is preferable that the rubbing member is configured to be movable in a direction different from the recording medium while pressing the surface of the resin image layer.

Moreover, it is preferable that the rubbing member has a softness. The softness of the rubbing member is, for example, preferably such softness that the surface of the rubbing member is deformed to a degree capable of following the shape of the surface of the resin image layer at the time of rubbing. That is, it is preferable that the rubbing member have a deformation followability. As a rubbing member which has such pliability, although a sponge and a rotating brush are mentioned, for example, it is not restricted to these.

The image forming method of the present invention may contain other steps such as a resin image layer forming step, a powder removing step, and an additional printing step, in addition to the powder supply step and the rubbing-adhering step.

### (Resin Image Layer Forming Step)

The image forming method of the present invention may further include a resin image layer forming step before the powder supply step.

In the resin image layer forming step, the resin image layer is formed on the recording medium. The method of forming the resin image layer on the recording medium is not particularly limited. For example, it is formed by applying a solution obtained by dissolving a heat-softening compound, a resin and optionally other components (e.g., a colorant) in a suitable solvent on the surface of a recording medium and drying it. In this case, the resin image layer may be coated by generally used methods such as gravure coating, roll coating, blade coating, extrusion coating, dip coating, or spin coating.

The resin image layer may be an image printed on a recording medium by a printing method such as an ink-jet method or an electrophotographic method. The formation of the image by the ink-jet method and the electrophotographic method may be performed by each of known image forming apparatuses.

From the viewpoint of easily obtaining the effects of the present invention, the resin image layer is preferably an image formed by electrophotography. In the electrophotographic method, toner particles are attached to an electrostatic latent image pattern on the surface of a photoreceptor to form a toner image, and the toner image is transferred to a recording medium such as paper. Here, toner particles that form a toner image generally contain a thermoplastic resin as a binder resin. Therefore, the image (toner image) formed by the electrophotographic method is likely to be softened or melted by heating, and therefore, it is considered that the effects of the present invention may be more remarkably exhibited.

Further, in the image forming method of the present invention, the resin image layer may be an image (unfixed image) before being fixed on the recording medium, or it may be a fixed image (fixed image). From the viewpoint of easily adhering powder on the surface of the resin image layer and forming an image having sufficient glossiness, the resin image layer is preferably a fixed image fixed on a recording medium. That is, the image forming method of the present invention preferably further includes a fixed image forming step before the powder supply step.

The fixed image forming step may be performed by a known fixed image forming apparatus, in particular, an image forming apparatus using an electrophotographic method. As an example of the fixed image forming method, a method may be adopted in which heat and pressure are applied by the fixing means to the recording medium to which the toner image has been transferred, and the toner image on the recording medium is fixed on the recording medium.

### (Powder Removing Step)

The image forming method of the present invention may further include a powder removing step after the powder supply step and the rubbing-adhering step. In the powder removing step, the powder not adhering to the resin image layer is removed from the recording medium. At this time, the powder particles removed from the recording medium may be recovered and reused. That is, the image forming method of the present invention may further contain a powder recovering step to recover the powder that did not adhere to the resin image layer after the powder supply step and the rubbing-adhering step. As described above, it is preferable to recover excess powder that has not been used for decoration from the viewpoint of economy and reducing the environmental load.

The method for removing or recovering the powder particles is not particularly limited, and may be performed by a known method. Examples thereof are: a method of scraping with a member such as a brush or a brush; a method of removing with an adhesive member such as an adhesive tape; and a method of sucking with a known device such as a powder collector capable of sucking or adsorbing powder particles. Thus, as the powder removing device (member) or the powder recovering device (member) for performing the powder removing step or the powder recovering step, as described above, it is possible to use a member such as a brush, an adhesive member having adhesiveness to powder particles, and a dust collector having a suction member for sucking powder particles. When the powder particles are a magnetic powder, a powder collector having a magnet member may be used.

### (Additional Printing Step)

The image forming method of the present invention may further include an additional printing step after the powder supply step and the heating step, or after the rubbing-adhering step and/or the powder removing step performed as needed. In the additional printing step, an image is further formed on a recording medium having a powder-adhered resin image layer (that is, a gloss image that has already been decorated). The additional printing method is not particularly limited, and a known method may be used. For example, a printing method such as an ink-jet method or an electrophotographic method may be used. In addition, a known device may be used as a printing device for performing the additional printing step. From the viewpoint of further improving the added value of the printed matter, it is preferable to further carry out the additional printing step.

### (Fixing Step)

In the image forming method of the present invention, after the powder supply step, or after the rubbing-adhering step, the powder removing step and/or the additional printing step which are performed as necessary, it is also preferable to contain a fixing step when needed. The fixing step is not particularly limited, and may be performed by a known fixing image forming apparatus, in particular, an image forming apparatus using an electrophotographic method. As an example of the fixed image forming method, a method may be adopted in which heat and pressure are applied by the fixing means to the recording medium to which the toner image has been transferred, and the toner image on the recording medium is fixed on the recording medium.

Further, it is also preferable that the fixing step is performed by light irradiation. The irradiation conditions may be adjusted as appropriate.

### [Image Forming Apparatus]

The image forming apparatus for carrying out the image forming method of the present invention preferably contains a powder supply means for supplying powder particles onto a resin image layer formed on a recording medium which is melted or softened by heat, a heating means for heating the resin image layer, and a rubbing means for rubbing the resin image layer to which the powder particles are supplied (the resin image layer to which the powder particles are attached) to adhere the powder particles. And further, it may contain, when needed, a powder removing means (preferably, powder recovery means) for removing from the recording medium the powder particles not adhering to the resin image layer; an image forming means (additional printing means) for forming an image on a recording medium having a resin image layer (that is, a gloss image already decorated) to which the powder particles are attached; and a means for fixing the image. These rubbing means, powder removing means (preferably, powder recovery means), image forming means (additional printing means) and fixing means may be provided in the image forming apparatus singly or in combination of two or more. Among them, it is preferable that the image forming apparatus further includes the above-described image forming means (additional printing means) from the viewpoint of enhancing the productivity of an image having high added value.

The specific description of the above-mentioned powder supply means, heating means, rubbing means, powder removing means (powder recovery means), image forming means (additional printing means), and fixing means are described in the description of the above steps.

The image forming device described above may be provided in the same enclosure as the enclosure where the fixed image forming device described above is provided, or it may be provided outside the enclosure where the fixed image forming device is provided.

### EXAMPLES

Hereinafter, the present invention will be specifically described by way of examples, but the present invention is not limited thereto. In addition, although the term “part” or “%” is used in an Example, unless otherwise indicated, it represents “mass part” or “mass %”.

### [Preparation of Toner]

### <Preparation of Black Dispersion Liquid>

11.5 mass parts of sodium n-dodecyl sulfate were added to 160 mass parts of ion-exchanged water, and they were dissolved and stirred to prepare an aqueous surfactant solution. In this surfactant aqueous solution, 15 mass parts of a colorant (carbon black: MOGUL™ L) were gradually added, and dispersion treatment was performed using “CLEARMIX W Motion CLM-0.8” (M Technique Co., Ltd., “CLEARMIX” is a registered trademark of the company). Thus, a liquid (black dispersion liquid) in which fine particles of the black colorant were dispersed was prepared. The particle size of the fine particles of the black colorant in the black dispersion liquid was 220 nm in terms of volume-based median diameter. The volume-based median diameter was determined by measurement using “MICROTRAC UPA-150” (manufactured by HONEYWELL Co. Ltd.) under the following measurement conditions.

Sample refractive index: 1.59

Sample specific gravity: 1.05 (in terms of spherical particles)

Solvent refractive index: 1.33

Solvent viscosity: 0.797 (30° C.), 1.002 (20° C.)

0 point adjustment: Ion-exchanged water was added to the measurement cell for adjustment.

### <Preparation of Core Resin Particles>

The core resin particles having a multilayer structure were prepared through the first stage polymerization, the second stage polymerization, and the third stage polymerization as described below.

### (a) First Stage Polymerization

Into a reaction vessel equipped with a stirrer, a temperature sensor, a cooling tube, and a nitrogen introducing device, a surfactant aqueous solution 1 containing 4 mass parts of sodium polyoxyethylene-2-dodecyl ether sulfate dissolved in 3,040 mass parts of ion-exchanged water were charged. The temperature of the solution was raised to 80° C. while stirring at a stirring speed of 230 rpm under a nitrogen stream. Into the surfactant aqueous solution 1 was added a polymerization initiator solution 1 containing 10 mass parts of potassium persulfate dissolved in 400 mass parts of ion-exchanged water. After raising the temperature of the mixed solution to 75° C., a mixed monomer solution 1 containing the following components in the following amounts was added dropwise to the mixed solution over 1 hour.

Styrene: 532 mass parts

n-Butyl acrylate: 200 mass parts

Methacrylic acid: 68 mass parts

n-Octyl mercaptan: 16.4 mass parts

After dropping the mixed monomer solution 1, the reaction system was heated and stirred at 75° C. for 2 hours to carry out the polymerization (first stage polymerization). Thus, resin particles A1 were prepared.

### (b) Second Stage Polymerization

Into a reaction vessel equipped with a stirrer was added a mixed monomer solution 2 containing the following components in the following amounts. Further, 93.8 mass parts of paraffin wax HNP-57 (manufactured by Nippon Seiro CO. Ltd.) as a releasing agent were added, the inner temperature of the reaction vessel was heated to 90° C. to dissolve the mixture.

Styrene: 101.1 mass parts

n-Butyl acrylate: 62.2 mass parts

Methacrylic acid: 12.3 mass parts

n-Octyl mercaptan: 1.75 mass parts

In a separate vessel, a surfactant aqueous solution 2 was prepared by dissolving 3 mass parts of sodium polyoxyethylene-2-dodecyl ether sulfate in 1,560 mass parts of ion-exchanged water, and it was heated to 98° C. 32.8 mass parts of the resin particles A1 were added to the surfactant aqueous solution 2, and the mixed monomer solution 2 was further added. The reaction system was mixed and dispersed for 8 hours by using a mechanical disperser with a circulation route “CLEARMIX” (manufactured by M Technique Co., Ltd.) so that an emulsified particle dispersion liquid 1 having a particle size of 340 nm was prepared. To this emulsified particle dispersion 1, a polymerization initiator solution 2 containing 6 mass parts of potassium persulfate dissolved in 200 mass parts of ion-exchanged water was added. Polymerization (second stage polymerization) was carried out by heating and stirring the system at 98° C. for 12 hours to prepare resin particles A2. Thus a dispersion liquid of resin particles A2 was obtained.

### (c) Third Stage Polymerization

A polymerization initiator solution 3 prepared by dissolving 5.45 mass parts of potassium persulfate in 220 mass parts of ion-exchanged water was added to the obtained dispersion liquid of resin particles A2. To this dispersion liquid, a mixed monomer solution 3 containing the following components in the following amounts was dropwise added at a temperature of 80° C. over 1 hour.

Styrene: 293.8 mass parts

n-Butyl acrylate: 154.1 mass parts

n-Octyl mercaptan: 7.08 mass parts

After completion of the dropwise addition, polymerization was carried out by heating and stirring for 2 hours (third stage polymerization) and then cooled to 28° C. to obtain core resin particles.

### <Preparation of Shell Resin Particles>

Polymerization reaction was carried out in the same manner as preparation of the core resin particles except that the mixed monomer solution 1 used in the first stage polymerization in the production of the core resin particles was changed to a mixed monomer solution 4 containing the following components in the following amounts. The process after reaction was performed and the shell resin particle were produced.

Styrene: 624 mass parts

2-Ethylhexyl acrylate: 120 mass parts

Methacrylic acid: 56 mass parts

n-Octyl mercaptan: 16.4 mass parts

### [Preparation of Black Toner Particles]

### (a) Preparation of Core Portion

Into a reaction vessel equipped with a stirrer, a temperature sensor, a cooling tube, and a nitrogen introducing device were added the following components in the following amounts and stirred. After adjusting the temperature of the obtained mixed solution to 30° C., a 5 mol/liter aqueous sodium hydroxide solution was added to the mixed solution to adjust its pH in the range of 8 to 11.

Core resin particles: 420.7 mass parts

Ion-exchanged water: 900 mass parts

Black dispersion liquid: 300 mass parts

Next, an aqueous solution containing 2 mass parts of magnesium chloride hexahydrate dissolved in 1000 mass parts of ion-exchanged water was added at 30° C. for 10 minutes with stirring. After leaving still for 3 minutes, the temperature of the mixture was raised, the system was heated to 65° C. for 60 minutes, and the particle growth reaction was continued. In this state, the particle size of the associated particles was measured with “Multisizer 3” (manufactured by Colter, Inc.), and when the volume-based median diameter became 5.6 μm, an aqueous solution containing 40.2 mass parts of sodium chloride dissolved in 1000 mass parts of ion-exchange water was added to stop particle growth. After the association was stopped, the core portion was produced by continuing the fusion of the associated particles by heating and stirring for 1 hour at a liquid temperature of 70° C. as an aging treatment. When the average circularity of the core portion was measured by “FPIA2100” (manufactured by Sysmex Corporation, “FPIA” is a registered trademark of the company), it was 0.912.

### (b) Preparation of Shell

Next, the mixed solution was heated to 65° C., and 50 mass parts of shell resin particles were added to the mixed solution, and further, an aqueous solution containing 2 mass parts of magnesium chloride hexahydrate dissolved in 1000 mass parts of ion-exchanged water was added to the above mixture over 10 minutes. Thereafter, the mixture was heated to 70° C. and stirred for 1 hour. In this manner, the shell resin particles were fused to the surface of the core portion, and then aged at 75° C. for 20 minutes to form a shell. Then, an aqueous solution containing 40.2 mass parts of sodium chloride dissolved in 1000 mass parts of ion-exchange water was added to stop shell formation. Further, it was cooled to 30° C. at a rate of 8° C./min. The produced particles were filtered, washed repeatedly with ion-exchanged water at 45° C., and then dried with hot air at 40° C., thereby producing black toner mother particles having a shell covering the surface of the core portion.

### (c) External Additive Addition Process

The following external additives were added to the black toner mother particles, and external addition processing was performed with “Henschel mixer” (manufactured by Nippon Coke & Engineering Co., Ltd.) to produce black toner particles.

Silica particles treated with hexamethylsilazane: 0.6 mass parts

Titanium dioxide particles treated with N-octylsilane: 0.8 mass parts

The external addition process using a Henschel mixer was performed under the conditions of a stirring blade peripheral speed of 35 m/second, a processing temperature of 35° C., and a processing time of 15 minutes. The particle size of the silica particles of the external additive was 12 nm in terms of volume-based median diameter, and the particle size of the titanium dioxide particles was 20 nm in terms of volume-based median diameter.

### [Preparation of Black Developer]

Black toner particles were mixed with ferrite carrier particles having a volume average particle diameter of 40 μm in an amount such that the toner concentration was 6 mass %. The surface of ferrite carrier particles was coated with a copolymer of methyl methacrylate and cyclohexyl methacrylate. Thus, a black developer was prepared.

### Example 1

Using POD Gloss Coat (basis weight 128 g/m², made by Oji Paper Co. Ltd.) as a recording medium, black developer was loaded in a modified machine of “AccurioPress C2060” (manufactured by Konica Minolta, Inc., “AccurioPress” is a registered trademark of the same company). A square patch image of 2 cm×2 cm was formed on a recording medium using the modified machine, and a toner image (resin image) having the patch image was output on the recording medium. The resin image was placed on a hot plate heated to 90° C., with the patch image facing up. On the patch image, 0.042 g of METASHINE 2025PS (average major axis 25 μm and average thickness 2 μm, manufactured by Nippon Sheet Glass Co., Ltd.) was scattered. The surface of the patch image of the resin image was rubbed for 10 seconds so that the powder particles were tanned with a rotating brush to adhere the powder particles, and the excess powder particles were removed. The cross section of the powder decoration image created as described above was observed. It was found that the powder particles were attached so as to form a single layer, the exposure ratio of the powder particles that were at least partially exposed was 90%, and the average exposure amount of the powder particles that were at least partially exposed was 38%, and the coverage was 54%.

### Example 2

A powder decoration image was prepared by setting the hot plate temperature of Example 1 to 120° C. and the rubbing time with a rotating brush to 10 seconds. The cross section of the powder decoration image was observed. It was found that the powder particles were attached so as to form a single layer, the exposure ratio of the powder particles that were at least partially exposed was 85%, and the average exposure amount of the powder particles that were at least partially exposed was 10%, and the coverage was 31%.

### Example 3

A powder decoration image was prepared by setting the hot plate temperature of Example 1 to 85° C. and the rubbing time with a rotating brush to 10 seconds. The cross section of the powder decoration image was observed. It was found that the powder particles were attached so as to form a single layer, the exposure ratio of the powder particles that were at least partially exposed was 90%, and the average exposure amount of the powder particles that were at least partially exposed was 50%, and the coverage was 78%.

### Example 4

A powder decoration image was prepared by setting the hot plate temperature of Example 1 to 85° C., with 0.012 g of powder particles having an average major axis of 5.0 μm and an average thickness of 0.5 μm (produced by the method described in paragraph [0037] of Japan Registered Patent No. 562564) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 95%, and the average exposure amount of the powder particles that were at least partially exposed was 42%, and the coverage was 68%.

### Example 5

A powder decoration image was prepared by setting the hot plate temperature of Example 1 to 100° C., with 0.068 g of powder particles having an average major axis of 500 μm (prepared by sieving METASHINE 5480PS manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 90%, and the average exposure amount of the powder particles that were at least partially exposed was 45%, and the coverage was 34%.

### Example 6

A powder decoration image was prepared by setting the hot plate temperature of Example 1 to 100° C., with 0.068 g of powder particles METASHINE 5090PS (an average major axis of 90 μm and an average thickness of 5.0 μm, manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 92%, and the average exposure amount of the powder particles that were at least partially exposed was 47%, and the coverage was 39%.

### Example 7

A powder decoration image was prepared by setting the hot plate temperature of Example 1 to 85° C., with 0.012 g of powder particles having an average particle size of 13 μm and an average thickness of 0.2 μm (produced by the method described in paragraph [0037] of Japan Registered Patent No. 562564) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 95%, and the average exposure amount of the powder particles that were at least partially exposed was 49%, and the coverage was 78%.

### Example 8

A powder decoration image was prepared by setting the hot plate temperature of Example 1 to 90° C., with 0.066 g of powder particles METASHINE 2025PS (an average major axis of 25 μm and an average thickness of 2 μm, manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 95%, and the average exposure amount of the powder particles that were at least partially exposed was 48%, and the coverage was 80%.

### Example 9

A powder decoration image was prepared by setting the hot plate temperature of Example 1 to 90° C., with 0.0084 g of powder particles METASHINE 2025PS (an average major axis of 25 μm and an average thickness of 2 μm, manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 80%, and the average exposure amount of the powder particles that were at least partially exposed was 15%, and the coverage was 30%.

### Example 10

A powder decoration image was prepared by setting the hot plate temperature of Example 1 to 150° C. and the rubbing time with a rotating brush to 10 seconds. The cross section of the powder decoration image was observed. It was found that the powder particles were attached so as to form two layers, the exposure ratio of the powder particles that were at least partially exposed was 85%, and the average exposure amount of the powder particles that were at least partially exposed was 39%, and the coverage was 59%.

### Example 11

A powder decoration image was prepared by setting the hot plate temperature of Example 1 to 120° C. and the rubbing time with a rotating brush to 15 seconds. The cross section of the powder decoration image was observed. It was found that the powder particles were attached so as to form a single layer, the exposure ratio of the powder particles that were at least partially exposed was 90%, and the average exposure amount of the powder particles that were at least partially exposed was 8%, and the coverage was 32%.

### Example 12

A powder decoration image was prepared by setting the hot plate temperature of Example 1 to 90° C. and the rubbing time with a rotating brush to 5 seconds. The cross section of the powder decoration image was observed. It was found that the powder particles were attached so as to form a single layer, the exposure ratio of the powder particles that were at least partially exposed was 90%, and the average exposure amount of the powder particles that were at least partially exposed was 55%, and the coverage was 75%.

### Example 13

A powder decoration image was prepared by setting the hot plate temperature of Example 1 to 85° C., with 0.012 g of powder particles having an average major axis of 3.0 μm and an average thickness of 0.3 μm (produced by the method described in paragraph [0037] of Japan Registered Patent No. 562564) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 90%, and the average exposure amount of the powder particles that were at least partially exposed was 21%, and the coverage was 69%.

### Example 14

A powder decoration image was prepared by setting the hot plate temperature of Example 1 to 100° C., with 0.068 g of powder particles having an average major axis of 510 μm (prepared by sieving METASHINE 5480PS manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 90%, and the average exposure amount of the powder particles that were at least partially exposed was 49%, and the coverage was 36%.

### Example 15

A powder decoration image was prepared by setting the hot plate temperature of Example 1 to 85° C., with 0.012 g of non-flat powder particles having an average major axis of 15 μm and an average thickness of 5 μm (produced by the method described in paragraph [0037] of Japan Registered Patent No. 562564) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 91%, and the average exposure amount of the powder particles that were at least partially exposed was 41%, and the coverage was 44%.

### Example 16

A powder decoration image was prepared by setting the hot plate temperature of Example 1 to 85° C., with 0.036 g of powder particles having an average major axis of 90 μm and an average thickness of 5.5 μm (produced by the method described in paragraph [0037] of Japan Registered Patent No. 562564) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 92%, and the average exposure amount of the powder particles that were at least partially exposed was 45%, and the coverage was 40%.

### Example 17

A powder decoration image was prepared by setting the hot plate temperature of Example 1 to 85° C., with 0.012 g of powder particles having an average major axis of 12 μm and an average thickness of 0.12 μm (produced by the method described in paragraph [0037] of Japan Registered Patent No. 562564) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 93%, and the average exposure amount of the powder particles that were at least partially exposed was 51%, and the coverage was 76%.

### Example 18

A powder decoration image was prepared by setting the hot plate temperature of Example 1 to 90° C., with 0.090 g of powder particles METASHINE 2025PS (an average major axis of 25 μm and an average thickness of 2 μm, manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 98%, and the average exposure amount of the powder particles that were at least partially exposed was 49%, and the coverage was 82%.

### Example 19

A powder decoration image was prepared by setting the hot plate temperature of Example 1 to 90° C., with 0.005 g of powder particles METASHINE 2025PS (an average major axis of 25 μm and an average thickness of 2 μm, manufactured by Nippon Sheet Glass Co., Ltd.) scattered on the patch image, and by setting the rubbing time with a rotating brush to 10 seconds. The cross section of the powder decoration image was observed. It was found that the powder particles were attached so as to form a single layer, the exposure ratio of the powder particles that were at least partially exposed was 81%, and the average exposure amount of the powder particles that were at least partially exposed was 39%, and the coverage was 28%.

### Comparative Example 1

A powder decoration image was prepared by setting the hot plate temperature of Example 1 to 90° C. and the rubbing time with a rotating brush to 10 seconds, then heat-pressing for 30 seconds through a PI sheet on a 200° C. hot plate, and peeling off the sheet after cooling. The cross section of the powder decoration image was observed. It was found that the powder particles were attached so as to form a single layer, but they were completely buried in the toner image. The exposure ratio of the powder particles that were at least partially exposed was 0%, and the average exposure amount of the powder particles that were at least partially exposed was 0%.

### Comparative Example 2

A powder decoration image was prepared by setting the hot plate temperature of Example 1 to 85° C. and the rubbing time with a rotating brush to 5 seconds. The cross section of the powder decoration image was observed. It was found that the powder particles were attached so as to form a single layer, the exposure ratio of the powder particles that were at least partially exposed was 78%, and the average exposure amount of the powder particles that were at least partially exposed was 40%, and the coverage was 35%.

### <Calculation of Exposure Amount of Powder Particles>

### (Cross-Sectional Observation Method)

A powder decoration image with powder particles adhered to the surface of the resin image layer was cut out and was solidified with an embedding resin. Then, a cutting sample was prepared. The cutting surface was ion milled with an ion milling device to produce a sample for cross-sectional observation. The observation sample was observed, for example, with an ultra-high resolution field emission scanning electron microscope (S-4800, manufactured by Hitachi High-Technologies Corporation) at a magnification at which ten powder particles adhered to the resin image layer were seen in one field of view. The observed image was binarized by LUSEX™-AP manufactured by Nireco Corporation, and the exposure amount of each powder particle was calculated by the following method. And the average value of each exposure amount calculated was made into an average exposure amount of powder particle, and was indicated in the following table.

### (Exposure Amount)

Exposure amount=(Perimeter of powder particles exposed from resin image layer in cross-sectional image)/(Total perimeter of powder particles in cross-sectional image)×100

Perimeter of exposed powder particles (exposed perimeter): Perimeter of the part exposed from the resin image layer

Total perimeter of powder particles: Length actually measured around the whole circumference of powder particles

### <Calculation of Exposure Ratio in Total Number of Powder Particles>

In the cross-sectional observation method, the total number of powder particles in one field of view and the number of powder particles having an exposure amount greater than 0% were counted, and the exposure ratio of the total number of powder particles was calculated. This was calculated in 10 arbitral fields of view, and the average value was adopted. Note that powder particles having a diameter of 3 μm or more were counted.

Exposure ratio=(Number of powder particles exposed from resin image layer)/(Total number of powder particles in cross-sectional image)×100

### <Average Major Axis, Average Thickness, and Shape of Powder Particles>

The powder particles were scattered and fixed on the double-sided tape, and the surface was observed with a microscope VHX-6000 at a magnification at which the shape of the powder particles was confirmed. The observed image was binarized by LUSEX™-AP manufactured by Nireco Corporation, measuring the major axis L, minor axis 1, and thickness t of 100 arbitral powder particles, and an average value was calculated. The maximum length of the powder particles was defined as the major axis L, the maximum length in the direction orthogonal to the major axis L was defined as the minor axis 1, and the minimum length in the direction orthogonal to the major axis L was defined as the thickness t. Further, in the case of a shape in which the ratio (l/t) of the minor axis 1 to the thickness t was 5 or more, it was defined as flat, and when it was less than 5, it was defined as non-flat. Note that the average major axis was also measured in Example 15 using non-flat powder particles.

### <Coverage>

The coverage was measured using a Keyence digital microscope VHX-6000 at a magnification of 100, and photographs were taken for 10 arbitral fields of view, and binarization processing was performed with LUSEX™-AP by Nireco Corporation. Each coverage was obtained for 10 fields of view by the following formula, and an average of these values was adopted.

Coverage=(Area exposed from the surface of the resin image layer when viewed from above the powder particles)/(Area of the surface of the resin image layer)×100

### [Evaluation]

<Metallic mirror feeling>

After the powder decoration image was formed as described above, it was measured with a goniometer device (variable angle spectroreflectance measuring device) (Goniophotometer GP-5, manufactured by Murakami Color Research Laboratory). The Misumi SUS sheet metal panel SFY-MTA/L110/X80 was used as the calibration plate. The calibration setting for data correction was set to a value 20.0/angle peak, and the panel meter was adjusted to 300. By setting an incident angle 45° and a tilt angle 0°, measurement was done with the receiving angle in the range of 0 to 90°. The integrated value of the amount of reflected light was calculated and evaluated according to the following criteria. There is a correlation between the integrated amount of reflected light of the goniophotometer and the sensory evaluation of the mirror feeling.

◯: The integral value of reflected light amount is 400 or more, a sufficient metallic mirror feeling is exhibited, and the metallic mirror feeling is recognized even with the naked eye.

Δ: The integral value of reflected light amount is 200 or more and less than 400, and comfortable metallic mirror feeling is exhibited with the naked eye.

X: The integral value of reflected light amount is less than 400, metallic mirror feeling is insufficient, and the background image is confirmed to be uneven or uneven even with the naked eye.

### <Detachability>

After applying the tape to the solid patch image decorated with powder and formed in a size of 5 cm×10 cm, the tape is peeled off by hand. The state of the image when the tape was peeled off was observed with the naked eye and a magnifying glass with a magnification of 10 times, and evaluated according to the following criteria.

The tape used was “Scotch Mending Tape MP-18 (manufactured by Sumitomo 3M Ltd.)”.

◯: No detached powder particles are confirmed by observation with a magnifying glass.

Δ: Although some detached powder particles were confirmed by observation with a magnifying glass, it is judged to be a level at which the non-uniformity or unevenness caused by the detachment is not confirmed with the naked eye.

X: Detached powder particles are confirmed by observation with the naked eye.

TABLE I

| | | Powder particles | | | | | | | Evaluation | | |
|---|---|---|---|---|---|---|---|---|---|---|---|
| | | | | Average | Average | | | | | Metallic | |
| | | Laminated | | major axis | thickness | | | Coverage | | mirror | |
| | Image | constitution | Shape | (μm) | (μm) | *1 | *2 | (%) | Detachability | feeling | Remarks |
| Example 1 | Black toner image | Single layer | Flat | 25 | 2.0 | 90 | 38 | 54 | ∘ | ∘ | Present invention |
| Example 2 | Black toner image | Single layer | Flat | 25 | 2.0 | 85 | 10 | 31 | ∘ | ∘ | Present invention |
| Example 3 | Black toner image | Single layer | Flat | 25 | 2.0 | 90 | 50 | 78 | ∘ | ∘ | Present invention |
| Example 4 | Black toner image | Single layer | Flat | 5 | 0.5 | 95 | 42 | 68 | ∘ | ∘ | Present invention |
| Example 5 | Black toner image | Single layer | Flat | 500 | 2.0 | 90 | 45 | 34 | ∘ | ∘ | Present invention |
| Example 6 | Black toner image | Single layer | Flat | 90 | 5.0 | 92 | 47 | 39 | ∘ | ∘ | Present invention |
| Example 7 | Black toner image | Single layer | Flat | 13 | 0.2 | 95 | 49 | 78 | ∘ | ∘ | Present invention |
| Example 8 | Black toner image | Single layer | Flat | 25 | 2.0 | 95 | 48 | 80 | ∘ | ∘ | Present invention |
| Example 9 | Black toner image | Single layer | Flat | 25 | 2.0 | 80 | 15 | 30 | ∘ | ∘ | Present invention |
| Example 10 | Black toner image | Two layers | Flat | 25 | 2.0 | 85 | 39 | 59 | ∘ | Δ | Present invention |
| Example 11 | Black toner image | Single layer | Flat | 25 | 2.0 | 90 | 8 | 32 | ∘ | Δ | Present invention |
| Example 12 | Black toner image | Single layer | Flat | 25 | 2.0 | 90 | 55 | 75 | Δ | ∘ | Present invention |
| Example 13 | Black toner image | Single layer | Flat | 3 | 0.3 | 90 | 21 | 69 | Δ | Δ | Present invention |
| Example 14 | Black toner image | Single layer | Flat | 510 | 2.0 | 90 | 49 | 36 | Δ | Δ | Present invention |
| Example 15 | Black toner image | Single layer | Non-flat | 15 | 5.0 | 91 | 41 | 44 | Δ | Δ | Present invention |
| Example 16 | Black toner image | Single layer | Flat | 90 | 5.5 | 92 | 45 | 40 | Δ | Δ | Present invention |
| Example 17 | Black toner image | Single layer | Flat | 12 | 0.1 | 93 | 51 | 76 | ∘ | Δ | Present invention |
| Example 18 | Black toner image | Single layer | Flat | 25 | 2.0 | 98 | 49 | 82 | Δ | Δ | Present invention |
| Example 19 | Black toner image | Single layer | Flat | 25 | 2.0 | 81 | 39 | 28 | ∘ | Δ | Present invention |
| Comparative | Black toner image | Single layer | Flat | 25 | 2.0 | 0 | 0 | 0 | ∘ | x | Comparative |
| example 1 | | | | | | | | | | | example |
| Comparative | Black toner image | Single layer | Flat | 25 | 2.0 | 78 | 40 | 35 | ∘ | x | Comparative |
| example 2 | | | | | | | | | | | example |

*1: Exposure ratio of the powder particles that are at least partially exposed (%)
*2: Average exposure amount of the powder particles that are at least partially exposed (%)

As shown in the above results, it is recognized that the toner image formed by the image forming method of the present invention has a higher metallic mirror feeling than the toner image formed by the image forming method of the comparative example, and the powder particles are hardly detached from the toner image formed by the image forming method of the present invention.

Although the embodiments of the present invention have been described and illustrated in detail, the disclosed embodiments are made for purpose of illustration and example only and not limitation. The scope of the present invention should be interpreted by terms of the appended claims.

What is claimed is:

1. An image forming method comprising the step of:
supplying powder particles to a resin image layer formed on a recording medium to adhere the powder particles to the resin image layer,
wherein 80% or more of the powder particles out of the total number of the powder particles adhered to a surface and an inside of the resin image layer are adhered so that at least a part of each powder particle is exposed from the resin image layer.

2. The image forming method descried in claim 1,
wherein the resin image layer is a toner image layer formed with an electrostatic image developing toner.

3. The image forming method descried in claim 1,
wherein an average exposure amount of each powder particle from the resin image layer is in the range of 10 to 50%.

4. The image forming method descried in claim 1,
wherein the powder particles are flat.

5. The image forming method descried in claim 4,
wherein the powder particles have an average major axis in the range of 5 to 500 μm and an average thickness in the range of 0.2 to 5 μm.

6. The image forming method descried in claim 1,
wherein the powder particles contain at least a metal or a metal oxide.

7. The image forming method descried in claim 1,
wherein a coverage of the resin image layer with the powder particles is in the range of 30 to 80%.
